(19) United States
(12) Patent Application Publication
(10) Pub. No.: US 2009/0045243 A1
(43) Pub. Date: Feb. 19, 2009

(54) Butt welding and feeding machine

(76) Inventor: Zhi-Huei Young, Taipei (TW)

Correspondence Address: Young, Zhi-Huei, P.O. Box 166-13, Taipei, 115, TW

(21) Appl. No.: 11/889,783

(22) Filed: Aug. 16, 2007

(51) Int. Cl. B23K 31/02

(52) U.S. Cl. 228/13

(57) ABSTRACT

Rolls of steel plates fed to a butt welding and feeding machine, a seamless welding between two adjoining juxtaposed steel plates must be first trimming off both butt ends or leading and trailing edge flanges. After trimming, the trimmed leading and trailing edges flush against each other. Welding torch opposite to a junction line moves along a transversal rail to weld two adjoining juxtaposed steel plates together. Preceding and following steel plates are fed with precision throughout both feeding, discharging rollers driven by servo motors. Steel plate held by a number of jaws urged by springs can reduce inner stress or friction happened between the steel plates; in addition, a gas cutting, machine for trimming off the butt ends, trimmed leading and trailing edges facilitate welding more promptly and efficiently. A good shelf at a front end of the machine can facilitate storing and fixing rolls of steel coil.

### FIELD OF THE INVENTION

The present invention relates to mechanical equipment, particularly to a butt welding and feeding machine.

### GROUND OF THE INVENTION

Steel plate is needed to be processed through ironware processing. For instance, ironware punching. At present, rolling thin steel plate to form rolls of steel plates is duly requested in processing work. But, prior to ironware punching or other processing work, the thin steel plate must be passed through a pre-treatment procedure. Ironware punching is to be continually well executed when feeding an unrolled steel plate not to pause the machine for the next series of strokes, following roll of steel plate fed to the machine must be continued to the immediate preceding punched unrolled steel plate. As a result, followed by fed steel plate is welded to a rear end of the immediate preceding punched steel plate to form a continuous steel plate by welding, which is almost performed by handy work at the same time. Whenever one of preceding unrolled steel plate is punched through the mechanic tool, the other steel plate must be prepared to add to the rear end of the preceding steel plate by welding instantly. Due to edge flanges of two juxtaposed steel plates are not completely flush against each other; a seamless welding is unlikely performed along a junction line of these two juxtaposed steel plates. To guarantee the products supplied in good shape and quantity, between a seamless welding, the steel plates must be performed promptly to fit market needs.

1. Firstly the edge of a preceding and a following steel plates are stacked together, and then they are combined integrally as a whole by welding.

2. Trimming the edges of both the preceding and the following steel plates by means of, for example, gas cutting machine; after trimming, both edges of two juxtaposed steel plates along the junction line are completely flush against each other, and a seamless welding is processed between the two steel plates, butted to each other.

However, two adjoining edges of the steel plates stacked together is unlikely a flat and smooth joint or seam during welding. Therefore, butt welding steel plates of prior arts as commercially available products are insufficient to accommodate customer's demand.

Needless to say, two steel plates with trimmed edges can improve performance of those welded steel plates. While a trimming process must be performed on both two juxtaposed steel plates; nevertheless, after trimming, these two trimmed edges are flush against each other. Most of feeding and butt welding machines adopted by the manufacturers are half automatic, it needs to make improvements to meet the requirements as mentioned above.

As we know, the trimming and welding processes must be completed step by steps consecutively; to what extent a manufacturing process can be performed automatically and promptly is necessitated an inner stress induced inside the steel plates can be eliminated. Since the preceding and following steel plates processed through trimming and welding, two juxtaposed steel plates must be required a junction rectifier etc., to eliminate deficiencies, such as originally flat surfaces of the juxtaposed steel plates may be out of shape along the junction line therebetween. At present, manual or half automatic operation is expected to fulfill such purpose of rectifying surfaces of steel plate or reducing abrasion from following cutting. Manufacturing efficiency is lowered, the quality of the products are also degraded.

### SUMMARY OF THE INVENTION

Accordingly, the present invention is to provide an automatic butt welding and feeding machine, steel plate can be processed through automatic feeding, trimming, welding, rectifying, and automatic discharging functions.

Point against aforesaid problems, the present invention is to provide an automatic butt welding and feeding machine comprising: an automatic feeding unit, a linear gripper, a positioning unit, a trimming unit, a welding unit and an automatic discharging unit. The automatic feeding unit includes feeding rollers driven by a first servo motor to impel (or move forward) a steel plate; the linear gripper, which is composed of a number of jaws, is disposed along a path to uplift the steel plate; the positioning unit disposed along the path to prevent the steel plate from turning aside; a rail equipped with left and right shields directs the steel plate to move forward; a trimming unit, disposed between the feeding and welding units accommodate the steel plate extending along (or being impelled) between upper and lower shear plates thereof; a welding unit includes a welding torch and a press element for pressing the steel plate tightly; an automatic discharging unit, includes discharging rollers driven by a second servo motor discharge the steel plate.

After adoption of aforesaid mechanism, the steel plate is exactly moved forward by a servo motor of automatic feeding unit, then moving forward movement of the steel plate is restricted by the linear gripper, and then the friction or abrasion between the steel plate and the trimming unit can be reduced; finally, turning leftward or rightward (i.e. turning aside) of the steel plate can be eliminated by the positioning unit, thus edges along junction line of the juxtaposed steel plates are fit well and flush against each other.

Moreover, feeding rollers of the feeding unit includes upper and lower rollers, the steel plate passed between the upper and lower rollers; in that, the upper roller is connected to a cylinder which drives the upper roller to press downward onto the lower roller, the servo motor is mainly to drive the lower roller to move forward the steel plate.

A number of jaws urged by springs respectively, unless the jaws are pressed downward or otherwise methods; the jaws are normally positioned higher than a shearing section of the lower shear plate of the trimming unit.

Trimming unit includes an upper shear plate driven by a cylinder and a lower shear plate disposed below the upper shear plate.

A welding torch of the welding unit disposed on a transversal rail, the welding torch welds two juxtaposed steel plates along the transversal rail; a pressing element of the welding unit includes left and right presses, both presses are pressed downward at an inclined angle, the welding torch is located in a middle of the left and right presses.

Discharging rollers of the automatic discharging unit includes upper and lower rollers; the steel plate passed between the upper and lower rollers; in which the upper roller is connected to a cylinder, drives the upper roller to press downward onto the lower roller, a servo motor mainly drives the lower roller to move forward the steel plate.

Moreover, point against aforesaid mechanism, a good shelf for storing rolls of steel plates is placed at (or incorporated to) a front end of the automatic feeding unit, good shelf includes; an expandable roller for fixing a roll of steel plate then feeding the roll of steel plate unrolled therefrom. A rectifier is disposed between the welding unit and the automatic discharging unit. The rectifier includes; sets of rectifying rollers distributed along upper and lower sides, steel plate passed through a gap between the upper and lower rollers. Impelling the steel plate by such sets of rollers, the steel plate can be rectified with flat surfaces to eliminate the inner stress.

The present invention is to provide functions of automatic feeding, trimming, welding, and rectifying etc. Butt welding and automatic feeding for the steel plate processing work can be realized, which is not only to speed up manufacturing and processing procedure, but also to improve butt welding steel plates produced in good shape with significant amount.

### BRIEF DESCRIPTION OF DRAWINGS

FIG. 1 shows a plan view of the first embodiment of the present invention;

FIG. 2 shows a perspective view of the first embodiment of the present invention;

FIG. 3 shows a top plan view of the first embodiment of the present invention;

FIG. 4 shows a sectional view of the first embodiment of the present invention;

FIG. 5 shows a schematic view of the mechanism of the first embodiment of the present invention;

FIG. 6 shows a plan view of the second embodiment of the present invention;

FIG. 7 shows a perspective view of the second embodiment of the present invention;

FIG. 8 shows a perspective view of a good shelf of the second embodiment of the present invention;

FIG. 9 shows a sectional view of a rectifier of the second embodiment of the present invention; and

FIG. 10 shows a schematic view of the mechanism of the second embodiment of the present invention.

### DETAILED DESCRIPTION OF THE PREFERRED EMBODIMENTS

The description is described in detail according to the appended drawings hereinafter.

### First Embodiment

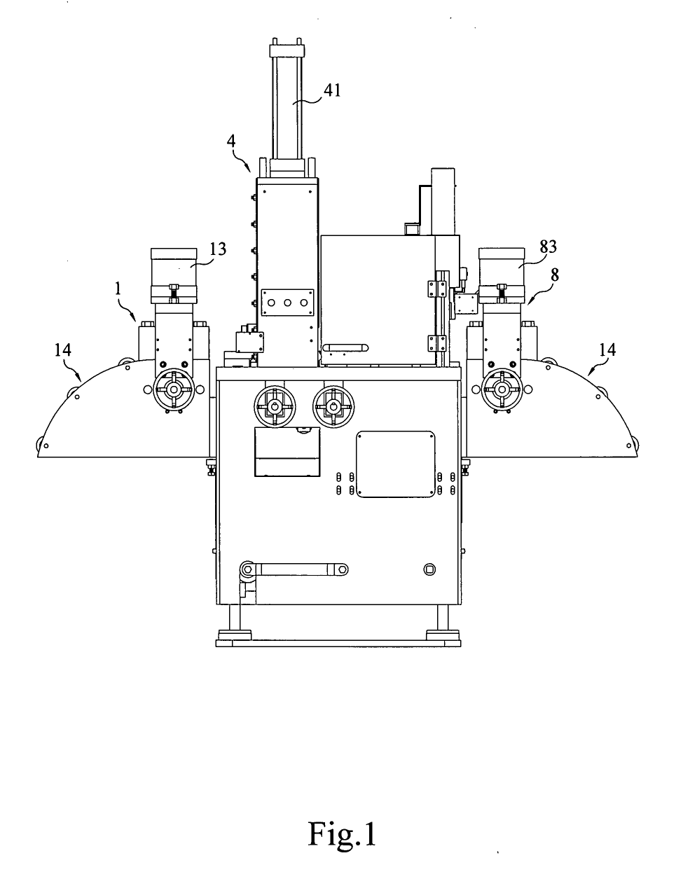

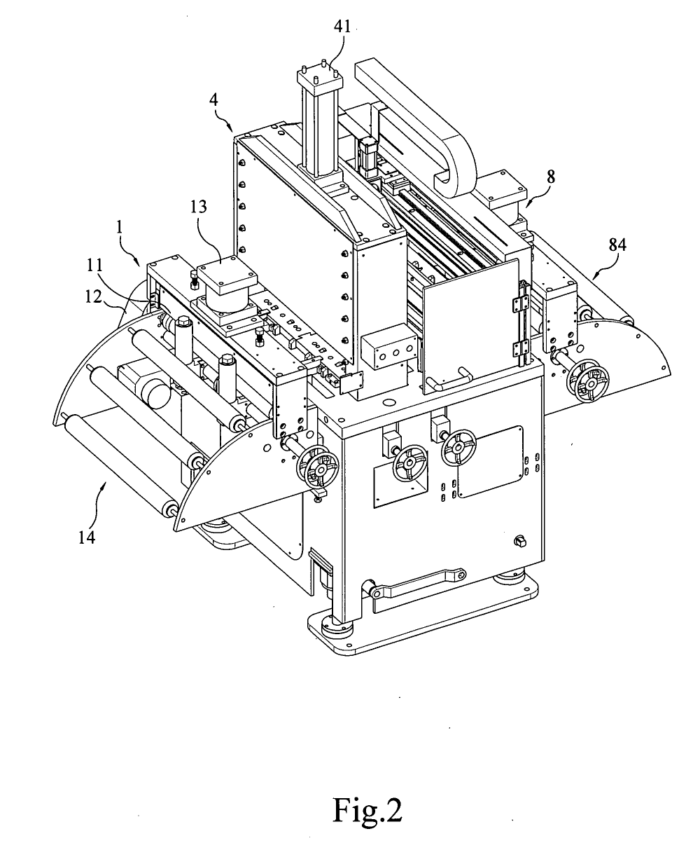

As shown in FIGS. 1-5, the first embodiment of butt welding and automatic feeding machine is illustrated. It includes an automatic feeding unit 1, a linear gripper 2, a positioning unit 3, a trimming unit 4, a welding unit 5, and an automatic discharging unit 8 installed to a frame of the machine. An automatic feeding unit 1 includes feeding rollers 11 driven by a servo motor 12 more exactly to determine feeding amount of a steel plate fed thereto. Rollers 11 of automatic feeding unit 1 includes upper and lower rollers 111, 112, can be assembled together by meshing gears in between. In which, the upper roller 111 is connected to and driven by a cylinder 13, but the lower roller 112 is connected to and driven by the servo motor 12. Therefore, the rollers 11 can be driven by both the cylinder 13 and the servo motor 12. As the steel plate passed between the upper and lower rollers 111, 112, the cylinder 13 drives the upper roller to press downward so as to mesh the gears between the upper and lower rollers. In addition, the lower roller 112 is driven by the servo motor 12. As a result, the steel plate is gradually moved forward by both the upper rollers 111 and the lower rollers 112. Lower rollers 112 are driven by the servo motor 12, which is designed for precision control in control of rolling angle of the lower roller 112 so as to determine feeding amount of the steel plate fed to the machine. When butt welding, it can ensure that edges along a junction line of two juxtaposed steel plates are exactly flush against each other. Furthermore, a set of feeding rollers 14 is disposed at a front end of the automatic feeding unit 1 to facilitate moving forward the steel plate.

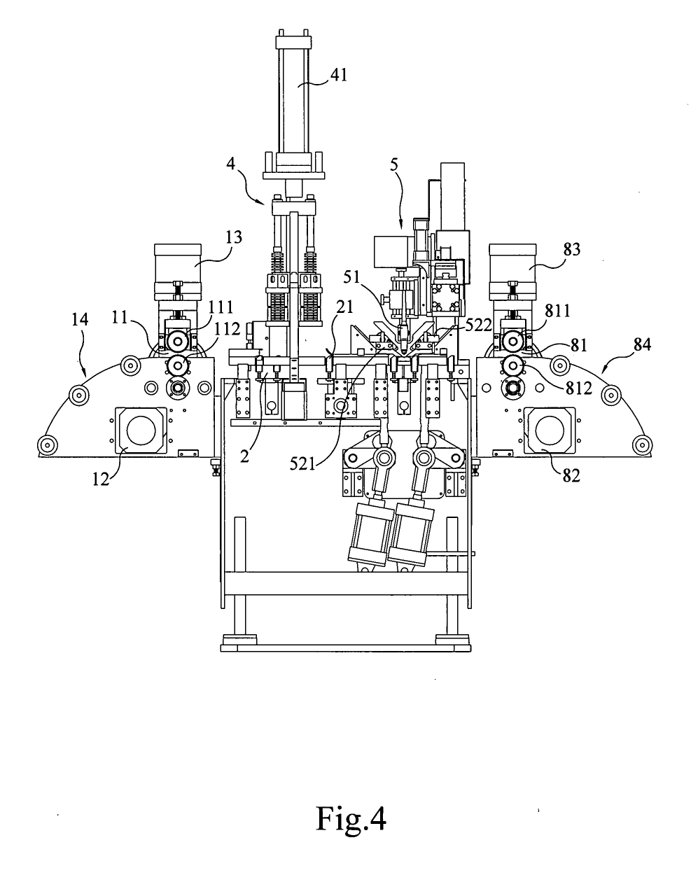

Linear gripper 2 is disposed along a path, where the steel plate is moving forward. As shown in FIG. 4, the linear gripper 2 is composed of a number of jaws 21, each of which is urged by a spring loaded therebelow respectively, therefore, the jaws 21 are normally positioned higher than a shearing section of a lower shear plate of the trimming unit 4; unless the jaws 21 are pressed downward or otherwise methods. Linear gripper 2 is designed to prevent the steel plate, when moving forward, from rubbing against or interfering with the lower shear plate of the trimming unit 4; otherwise feeding of the steel plate is happening an unexpected interruption. As a result, the steel plate can be uplifted to retain a gap above the lower shear plate. When the trimming unit 4 is to trim a leading edge flange of the feeding steel plate; the linear gripper 2 consists of the jaws 21 are pressed downward. Thus, the steel plate is in contact with the lower shear plate of the trimming unit 4 to finish trimming the leading edge flange of the feeding steel plate. After that, the linear gripper 2 is promptly to uplift the steel plate to process to next step.

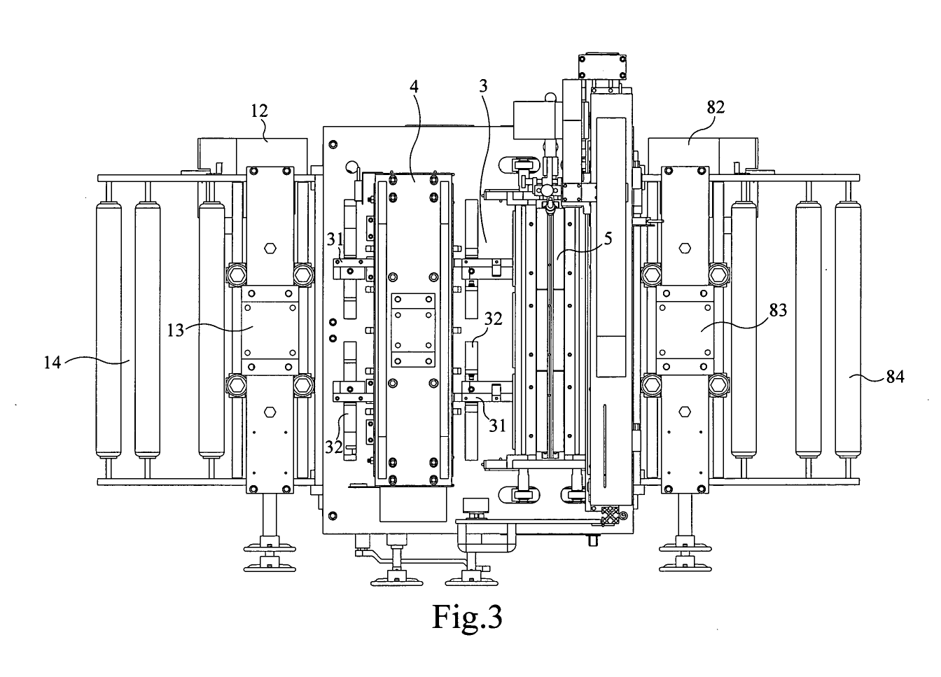

As shown in FIG. 3, a positioning unit 3 is designed to prevent adjoining plates from stacking together or crossing over upon adjoining edges. The positioning unit 3 is distributed along the path for moving forward the steel plate. The positioning unit 3 can define whether the steel plate is fed along the path. The positioning unit 3 has a pair of shields 31 located at both sides of the path, thus the shields 31 can determine a width of the path suitable for feeding the steel plate. Shields location 31 can be adjusted along the transversal rails 32; therefore, the positioning unit 3 can feed the steel plates with different widths. To prevent the positioning unit 3 from holding the steel plate too tight, it is necessary to keep a gap between the steel plates to both shields. Therefore, the steel plate can be moved forward smoothly. Each of the shield 31 is equipped with an optic fiber checker (not shown) opposite to each other inside the shields. Shields 31 on the rails 32 are adjusted their locations by a knob, when left or right edges of the steel plate interfere with light emitted by both optic fibers, the optic fiber checkers give an audible warning to address the users stop switch the knob.

Trimming unit 4 is disposed between the automatic feeding unit 1 and the welding unit 5, a steel plate extending along between upper and lower shear plates of trimming unit 4. Trimming unit 4 includes an upper shear plate driven by a cylinder 41 and a lower shear plate located below the upper shear plate. When manufacturing, steel plates processed through different manufacturing system; therefore, each of the steel plates may have butt ends, or flanges, so steel plates could not flush against each other by their adjoining edges. Although two adjoining steel plates are welded together, but the flanges are not connected by fusible metal, for example, tin solder, to form a seamless welding. To ensure a significant amount and good shaped steel plates manufactured through welding, two adjacent flanges of adjoining juxtaposed steel plates must be trimmed off by trimming unit in advance; thereby, butt welding plate can be formed with seamless welding.

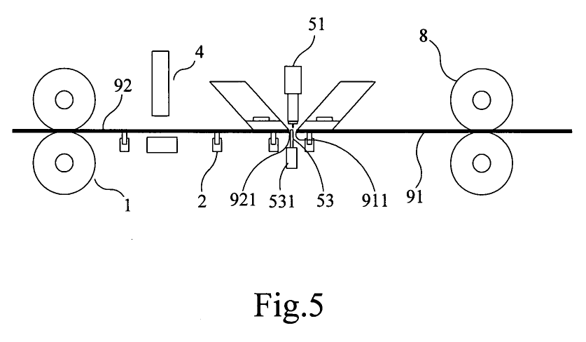

Steel plate passed through the trimming unit 4 is moved forward into the welding unit 5. Welding unit 5 includes a welding torch 51 and a pressing element 52 for pressing tightly onto steel plate. Welding torch 51 is installed to a transversal rail; the welding torch 51 is guided along the transversal rail to perform a manual or a full automatic welding task on the trimmed edges of two adjoining juxtaposed steel plates. The press element 52 includes left and right presses 521,522, both of the left and right presses 521, 522 are pressed downward with an inclined angle at 45 degrees. The welding torch 51 is located in a middle of the left and right presses 521,522. An inclined pressed downward movement is necessitated by the presses 521, 522 for leaving a spare space in between as a welding area of the welding torch 51. If the pair of presses 521, 522 press downward perpendicularly, a space kept between presses 521, 522 is too close for the welding torch 51 welds therealong. The welding unit 5 is substantially configured by the left and right presses 521, 522 mounted in a V-shaped branched plate, which has two sliding troughs, both of them are inclined at 45 degrees converged toward a median line as two “arms” or “branches” of the V-shaped branched plate (please referring FIGS. 4 and 5). A cylinder 531 disposed below the left and right presses 521,522 can activate both presses 521, 522 to press downward along the slide troughs respectively, until the presses 521,522 are pressed tightly on the steel plate. Furthermore, to ensure a seam between adjoining juxtaposed steel plates is on the right, opposite to the welding torch 51, a stopping pin 53 is disposed right below the welding torch 51. Stopping pin 53 is driven by the cylinder 531 to move the left and right presses 521, 522 higher or lower (referring FIGS. 4 and 5). When a trailing edge flange at a rear end of the preceding steel plate 91 is trimmed, the trimmed steel plate 91 is then passed through an automatic discharging unit 8 to move forward continuously. The trimmed trailing edge 911 of the steel plate 91 is first moved across the stopping pin 53 and then halted where it is ceased to move (which is controlled by the automatic discharging unit 8). At this time, the stopping pin 53 is driven by the cylinder 531 to uplift higher than the path to hinder the steel plate 91 feeding (or extending) forward continuously. Then the automatic discharging unit 8 drives the steel plate 91 moving backward till the trimmed trailing edge 911 is resisted against the uplifted stopping pin 53. Then the trimmed trailing edge 911 of the preceding steel plate 91 is placed right below the welding torch 51. In addition, the preceding steel plate 91 is pressed tightly by the right press 522, which is driven by the cylinder to move downward to exert a pressure to the steel plate 91. Meanwhile, the stopping pin 53 is moved downward and returned to its original location. Since the following steel plate 92 which is already trimmed off a leading edge flange, driven by automatic feeding unit 1 approaches the preceding steel plate 91. Until the trimmed leading edge 921 is flushed against the trimmed trailing edge 911 of the preceding steel plate 91, which is already pressed tightly by a right press 522. Thus, the preceding and following steel plates 91,92 are opposite to and closely in contact with each other by trimmed trailing and leading edges 911,921. After that, the left press 521 driven by the cylinder 531 is moved downward to press tightly on the trimmed leading edge 921 of the following steel plate 92. Both the preceding and following steel plates 91,92 are pressed tightly with their opposite trimmed trailing and leading edges 911,921 connected by fusible metal, for example, tin solder to each other integrally. The welding torch 51 is opposite to a seam (i.e. the junction line) between the two adjoining juxtaposed steel plates, the welding torch starts moving along the transversal rail to weld along the seam of two adjoining juxtaposed steel plates 91, 92. After welding, the two steel plates welded together integrally as a whole is driven by a servo motor 82 of the automatic discharging unit to move forward for processing through next step.

Automatic feeding unit 1 and automatic discharging unit 8 are substantially configured by the same components, such as feeding rollers 81 driven by the servo motor 82 to adjust a feeding amount of the steel plate. Feeding rollers 81 includes upper rollers 811 and lower rollers 812. In which, the upper rollers are connected and driven by a cylinder 83, the lower rollers are connected and driven by the servo motor 82 etc.

Automatic feeding unit 1 and automatic discharging unit 8 are cooperated with each other to move forward the steel plate. When a roll of steel plate is fed to this machine, the unrolled steel plate is first passed through the automatic feeding unit 1 to move forward consecutively. When one roll of steel plate is used up, the other roll of steel plate is needed to butt weld to the rear end of the immediate processing steel plate, the preceding steel plate is still moved forward by the automatic discharging unit 8, but the following steel plate is moved forward by the automatic feeding unit 1. Until these two adjoining juxtaposed steel plates are welded together integrally as a whole, which are moved forward by the automatic discharging unit 8 to a punch. Discharging rollers 84 is also installed to a rear end of the automatic discharging unit 8 to facilitate moving forward the steel plates throughout the welding task.

### Second Embodiment

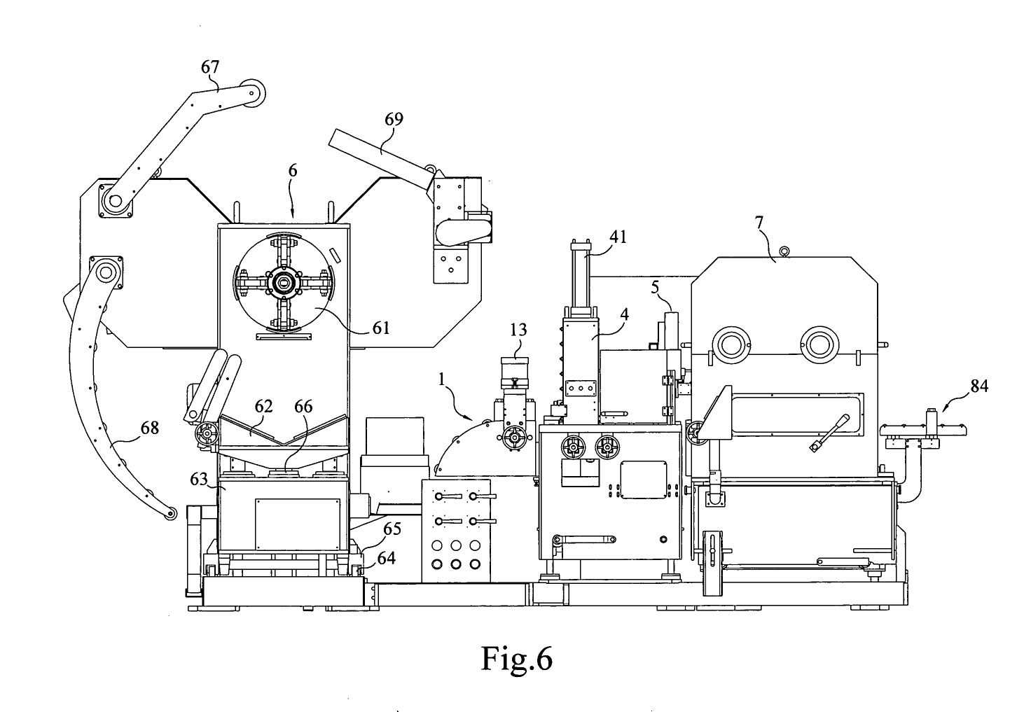

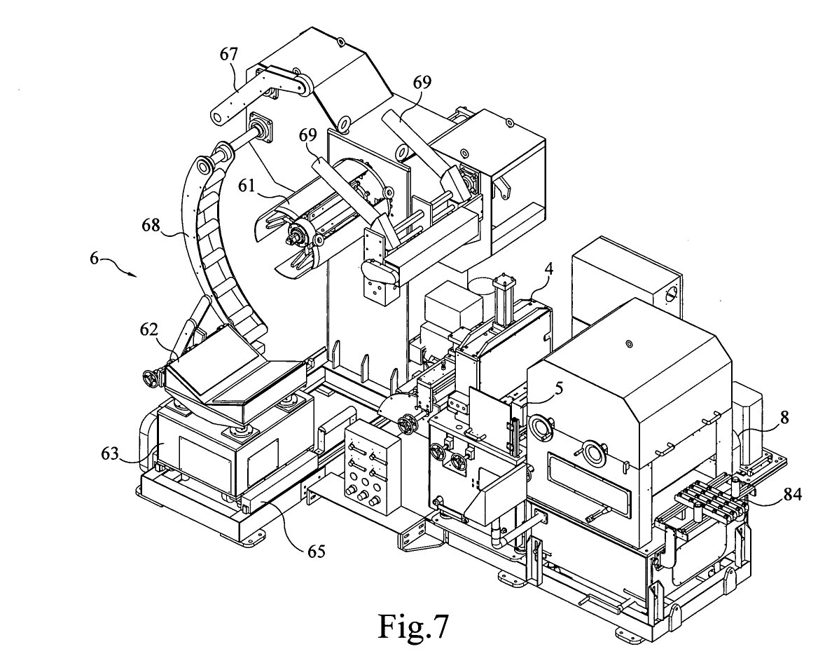

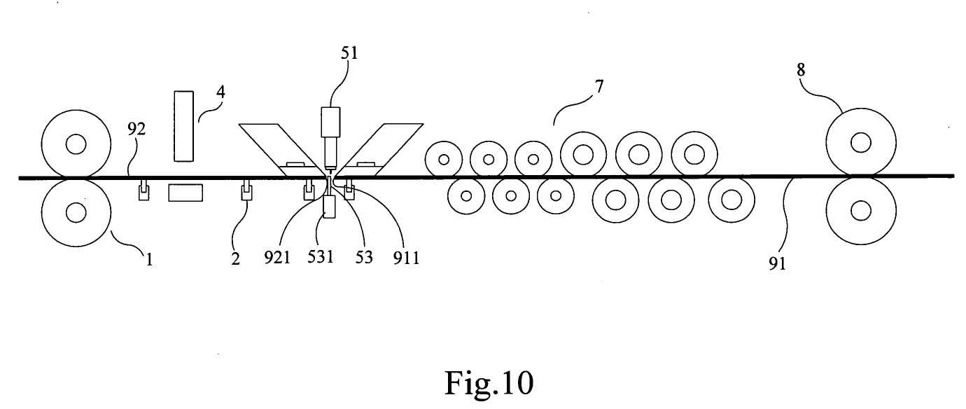

As shown in FIGS. 6-10, a second embodiment of the present invention is illustrated. The second embodiment is based on the first embodiment to add more components to the machine, such as a good shelf 6 for storing rolls of steel plates is added at a front end the automatic feeding unit 1, a rectifier 7 is disposed between the welding unit 5 and the automatic discharging unit 8.

The description described in detail hereinafter is mainly related to the components added to the machine to configure an alternative embodiment different from the first embodiment.

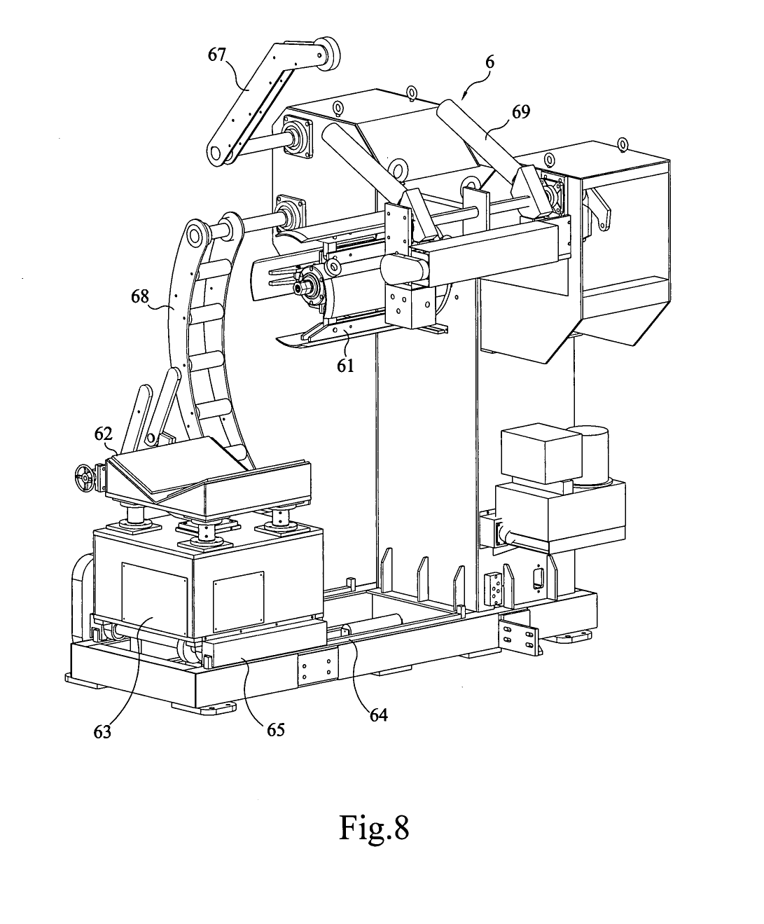

As shown in FIG. 8, a good shelf 6 includes an expandable roller 61 fixing a roll of steel plate to the good shelf, a trunk 62, which is driven by a cylinder 66 to move upward or downward, is disposed on a slide base 63 below the expandable roller 61. Because the roll of steel plate is rolled like a cylinder, an upper surface of the trunk 62 is concaved inward for receiving the roll of steel plate stably. The slide base 63 can be moved with linear movements by a sleeve 65 moved along a rail 66, so the slide base 63 can be moved toward the expandable roller 61. The cylinder 66 can impel the trunk 62 upward or downward to uplift the steel plate placed on the trunk 62. The trunk 62 is designed as a transport station for transferring rolls of the steel plates to the expandable roller 61.

During the transfer period, first a fork vehicle or other conveyance is applied to put rolls of steel plates onto the trunk 62. At that time, the trunk is remained at “floor level”, and the slide base 63 is located at a distant end away from the expandable roller 61 to facilitate placing rolls of steel plates. After the roll of steel plate is received into the trunk 62 in position stably, the slide base 63 driven by a motor is moved toward the expandable roller 61 along the rail 64. The trunk 62 is also uplifted by a cylinder simultaneously. The roll of steel plate is rolled to form a cylinder with an axle hole; the roll of steel plate is to be wrapped around an axle of the expandable roller 61. Accompanied by the sliding movements of the slide base 63, the rolled steel plate fits over the expandable roller 61. To facilitate inserting the expandable roller 61 into the axle hole of the roll of steel plate, the expandable roller 61 should shrink a diameter to an extent so as to fit through the axle hole of the roll of steel plate. The axle diameter of the expandable roller 61 can be reduced to the smallest and then the roller is substantially shaped as an axle-like roller 61. After the roller 61 is inserted into the axle hole of the rolled steel plate, the roller 61 is expanded to an extent as the diameter of the expandable roller is same as the diameter of the axle hole of the roll of steel plate. At that time, the roll of steel plate is fixed to the expanded roller 61 as wrapped around the expanded roller integrally. When the roll of steel plate is unrolled from the expandable roller that it is expanded for tightly support the steel plate, to be unrolled from the leading edge flange of a front end to the trailing edge flange of a rear end.

In practice, the roller surface is composed of a number of curved facets; all curved facet are connected to and driven by a cylinder. These curved facets driven by the cylinder to expand outward in radial direction; therefore the roller surface can be “expanded” to support the roll of steel plate to be unrolled therefrom.

Besides, the good shelf 6 also includes a press element 67, a left and a right shield 69 and a guided feeding element 68. All of them are disposed alongside the expandable roller 61 to facilitate moving forward steel plate. In which, the press element 67 is a swing arm, which is rotatable, with a roller at a distal end to press tightly onto a surface of the steel plate. Therefore, the rolled steel plate can be prevented from getting loose when a self generated strain happened to the rolled steel plate. The left and right shields 69 resist against two lateral sides of the unrolled steel plate respectively to prevent the steel plate from turning aside during transferring. The guided feeding element 68 is mainly shaped cambered outward; a proximal end of the feeding element 68 is hinged mount on the base of the good shelf 6. According to diameters of rolls of steel plates, the guided feeding element 68 is deflected at an angle in position suitable for loading rolls of steel plates with different diameters; the steel plate will be moved forward to next automatic feeding unit 1 along this guided feeding element 68.

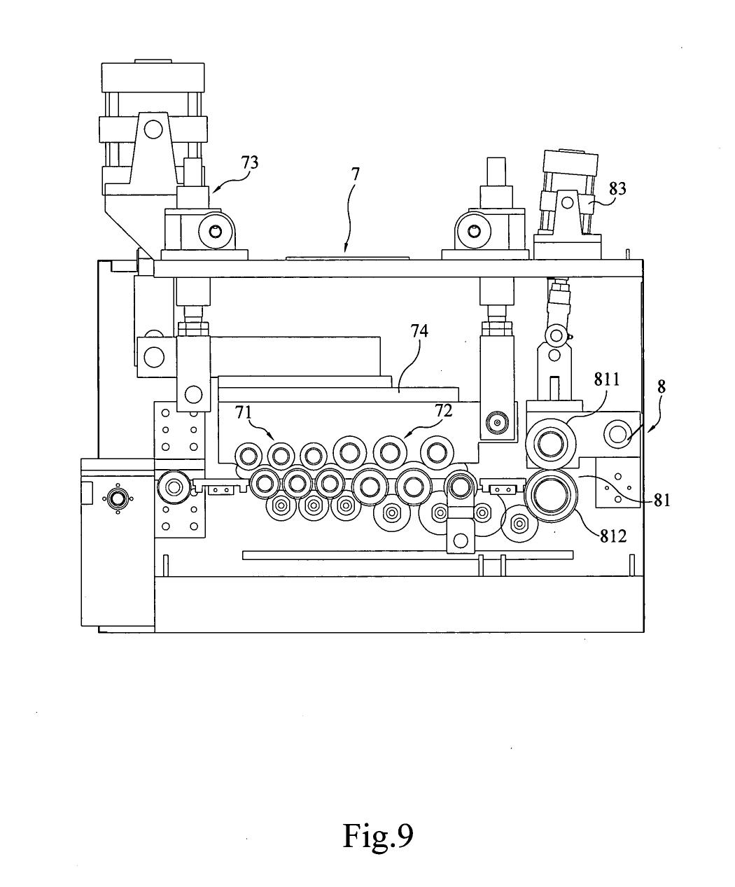

After a steel plate passed throughout the welding unit 5, a rectifier is provided for rectifying edges of the steel plate to reduce the inner stress. As FIG. 9 is shown, a rectifier 7 includes sets of rectifying rollers distributed higher or lower along a path for feeding forward a steel plate, which is extending along between these upper and lower rollers. As the rollers of the rectifier exert pressure to press edges of the steel plate; an inner stress of the steel plate is eliminated. Rectifier 7 is composed of sets of rollers 71, 72 with different diameters. The rollers are arranged in an up and down relationship, according to their different diameters, rollers divided into upper and lower series and opposite to each other, but each higher or lower rollers connected one by one are also meshed with the adjacent and opposite rollers consecutively and serially only to retain clearances between each opposite higher and lower rollers; rollers with different diameters are also cause different clearances in betweens and therefore spaced therefrom. In which, the upper rollers are installed on a branched plate 74, while the branched plate 74 driven by a cylinder 73 moves higher or lower or even deflects at an angle. Therefore, clearances formed among the upper and lower rollers can be adjusted.

Due to the rectifier 7 is mainly composed of sets of rollers distributed in an up and down relationship. Steel plate is passed through a “winding” path between the upper and lower rollers. As a result, pressure exerted by the rollers can rectify the edges of the steel plate and eliminated the inner stress of the steel plate. Therefore, a following punctured steel plate can be in good shape. The rectifying rollers of this embodiment consist of sets of rollers with two diameters. The rollers can be arranged in an up and down relationship or both upper and lower rollers of different diameters arrayed in jagged patterns interlock with each other.

Due to the clearances between rollers are different according to their diameters, the steel plate passed through a gap formed between the higher and lower rollers, an inner stress can be eliminated by the rolling press between rollers, and the rollers with different diameters can prevent the steel plate from, for example, crushes or dents.

Summarized up, the present invention is to provide a machine having automatic feeding, cutting, positioning, welding, rectifying, and leveling functions, the steel plate is processed through full automatic processes, to speed up manufacturing and elevate the butt welding quality.

Embodiments of the present invention are not to restrict the scope of the present invention, persons skill in the arts provide remedies or modifications of the structure, feature or principle according to the claims of the present invention should be confined in the claimed scope.

What is claimed:

1. An automatic butt welding and feeding machine comprising:
an automatic feeding unit (1), a linear gripper (2), a positioning unit (3), a trimming unit (4), a welding unit (5) and an automatic discharging unit (8);
the automatic feeding unit (1) includes feeding rollers (11) driven by a first servo motor (12) to impel (or move forward) a steel plate and determine a feed amount of the steel plate;
the linear gripper (2), which is composed of a number of jaws (21), is disposed along a path to uplift the steel plate;
the positioning unit (3) disposed along the path to prevent the steel plate from turning aside; a rail equipped with left and right shields (31) and a rail (32) adapted to the shields for directing the steel plate to move forward into a direction;
the trimming unit (4) disposed between the feeding unit (1) and welding unit (5) accommodates the steel plate extending along (or being impelled) between upper and lower shear plates thereof;
the welding unit (5) includes a welding torch (51) and a press element (52) for pressing the steel plate tightly; and
an automatic discharging unit (8) includes discharging rollers (81) driven by a second servo motor (82) discharge the steel plate.

2. An automatic butt welding and feeding machine according to claim 1 wherein the feeding rollers (11) of the feeding unit (1) includes upper and lower rollers (111, 112), the steel plate passed between the upper and lower rollers; in that, the upper roller (111) is connected to a cylinder (13), which drives the upper roller (111) to press downward onto the lower roller (112), the servo motor (12) is mainly to drive the lower roller (112) to move forward the steel plate.

3. An automatic butt welding and feeding machine according to claim 1 wherein a number of jaws (21) of the linear gripper (2) are urged by springs respectively, unless the jaws (21) are pressed downward or otherwise methods; the jaws (21) are normally positioned higher than a shearing section of the lower shear plate of the trimming unit.

4. An automatic butt welding and feeding machine according to claim 1 wherein the trimming unit (4) includes an upper shear plate driven by a cylinder (41) and a lower shear plate disposed below the upper shear plate.

5. An automatic butt welding and feeding machine according to claim 1 wherein the welding torch (51) of the welding unit (5) disposed on a transversal rail, the welding torch (51) welds a junction line between two adjoining juxtaposed steel plates along the transversal rail; a pressing element (52) of the welding unit includes left and right presses (521,522), both presses (521, 522) are pressed downward at an inclined angle, the welding torch (51) is located in middle of the left and right presses (521, 522).

6. An automatic butt welding and feeding machine according to claim 1 wherein discharging rollers (81) of the automatic discharging unit (8) includes upper and lower rollers (811, 812), the steel plate passed between the upper and lower rollers (811, 812); in which, the upper roller (811) is connected to a cylinder (83), which drives the upper roller (811) to press downward onto the lower roller (812), a servo motor (82) mainly drives the lower roller (812) to move forward the steel plate.

7. An automatic butt welding and feeding machine according to claim 1 wherein a good shelf (6) for storing rolls of steel plates is placed at a front end of the automatic feeding unit (1), said good shelf (6) includes an expandable roller (61) for fixing a roll of steel plate then feeding the roll of steel plate unrolled therefrom.

8. An automatic butt welding and feeding machine according to claim 1 wherein a rectifier (7) is disposed between the welding unit (5) and the automatic discharging unit (8), the rectifier includes sets of rectifying rollers distributed along the upper and lower sides, steel plate passed through a gap between the upper and lower rollers.

9. An automatic welding and feeding machine as claim 7 claimed wherein the expandable roller (61) of said good shelf (6) has a trunk (62) disposed below it, the trunk (62) is lifted higher or lower on a slide base (63) by a cylinder (66).

10. An automatic welding and feeding machine as claim 8 claimed wherein rectifying rollers (71,72) of said rectifier (7) includes sets of rollers with different diameters, the rollers are arranged in an up and down relationship, clearances between upper and lower rollers are different according to their diameters.
